(19) United States
(12) Patent Application Publication
(10) Pub. No.: US 2024/0145978 A1
(43) Pub. Date: May 2, 2024

(54) ELECTRICAL CONNECTOR ASSEMBLY

(71) Applicant: Hirose Electric Co., Ltd., Yokohama (JP)

(72) Inventors: Ryo YOKOYAMA, Yokohama (JP); Naoki NINOMIYA, Yokohama (JP)

(21) Appl. No.: 18/494,147

(22) Filed: Oct. 25, 2023

(30) Foreign Application Priority Data
Oct. 28, 2022 (JP) 2022-173014

(51) Int. Cl. H01R 13/502; H01R 12/71; H01R 31/06

(52) U.S. Cl. CPC H01R 13/5025; H01R 12/716; H01R 31/06; H01R 2101/00

(57) ABSTRACT

To provide an electrical connector assembly capable of reliably restricting the tilting of an adaptor connected to a connector to a predetermined angle or less, an electrical connector assembly includes a first connector, an adaptor, a tubular portion forming part of the adaptor with a supporting portion made of a rigid material, a plurality of resilient pieces, and engagement portions protruding radially outwardly from the distal end portions of the resilient pieces. The first connector involves a main body portion having an opening the main body portion has a peripheral wall forming a recess portion; and, when the adaptor is tilted a predetermined angle relative to the first connector while the adaptor is engaged in a mated state, the supporting portion restricts further tilting of the adaptor by abutting the peripheral wall.

### CROSS-REFERENCE TO RELATED APPLICATIONS

This application claims priority to Japanese Patent Application No. 2022-173014, filed Oct. 28, 2022, the contents of which are incorporated herein by reference in its entirety for all purposes.

### BACKGROUND

### Technical Field

The present invention relates to an electrical connector assembly that connects connectors via an adaptor.

### Related Art

Heretofore, there has been known an electrical connector assembly that connects a coaxial line used for radio-frequency signals to printed wiring boards. Such an electrical connector assembly comprises a first connector attached to one board, a second connector attached to another board, and an adaptor of a generally cylindrical outer shape that couples the first connector and the second connector to each other. The first and second connectors are attached in a manner to project vertically from the boards. Therefore, the two boards are connected by the electrical connector assembly while being spaced apart by the length of the electrical connector assembly and being generally parallel to each other.

In such an electrical connector assembly, the first connector and the adaptor are usually adapted to be mated using a locking arrangement, while the second connector and the adaptor are adapted to be coupled without use of a locking arrangement. In order to connect the electrical connector assembly, first, one end of the adaptor is inserted into and mated with the first connector attached to one board, whereupon, after positionally aligning the other board with said one board, the other board is pushed toward said one board. In doing so, the other end of the adaptor is inserted into the second connector, which makes it possible to connect the two boards to each other.

Usually, in order to allow for dimensional errors and the like, during attachment to the boards of the first and second connector, after one end of the adaptor has been mated with the first connector, the other end remains pivotally movable relative to said one end. In other words, the adaptor can be disposed in a tilted relationship with respect to the axial direction of the first connector in a manner to accommodate dimensional errors and the like. On the other hand, the second connector has an umbrella-like guiding portion expanding toward the first connector. For this reason, once the two boards are pushed toward each other, the other end of the adaptor is guided by the interior surface of the guiding portion in the direction of the central axis of the second connector, which allows for the other end of the adaptor to be properly inserted into the second connector.

However, when the angle of tilt of the adaptor was too large, there was a risk that once the two boards were pushed toward each other, the guiding portion of the second connector would be unable to guide the other end of the adaptor in the direction of the central axis of the second connector, and the electrical connector assembly, in particular, the adaptor, would fail.

Thus, Patent Document 1 (Japanese Published Patent Application No. 2017-69133) has disclosed providing a construction that restricts the tilting of an adaptor beyond a predetermined range in a similar electrical connector assembly. Specifically, one end of the adaptor of Patent Document 1 is of a generally cylindrically shaped construction. In this construction, a plurality of slits extending toward the distal end in the axial direction are formed in the circumferential direction, thereby producing resilient pieces capable of resilient deflection in the radial direction.

On the other hand, the first connector of Patent Document 1 has a peripheral wall that forms a recess portion for inserting one end of the adaptor. The electrical connector assembly of Patent Document 1 is designed such that the resilient pieces of the adaptor can abut the peripheral wall of the first connector once the adaptor is tilted relative to the first connector. In doing so, this electrical connector assembly is adapted to restrict the tilting of the adaptor by abutting the resilient pieces and the peripheral wall.

### PATENT DOCUMENTS

### Patent Document 1

Japanese Published Patent Application No. 2017-69133.

### SUMMARY

### Problems to be Solved

However, in the electrical connector assembly of Patent Document 1, the components that abut the peripheral wall of the first connector are the resilient pieces formed at one end of the adaptor. For this reason, the problem was that the peripheral wall of the first connector could not reliably restrict the resilient pieces because of the deflection of the resilient pieces. Therefore, in the electrical connector assembly of Patent Document 1, there was a risk that the adaptor could end up in a significantly tilted state because of the deflection of the resilient pieces when, for example, an external force was applied to the adaptor in the radial direction while the resilient pieces and the peripheral wall were in abutment. Once the adaptor is significantly tilted beyond the allowable range, the adaptor is no longer guided by the guiding portion in the direction of the central axis of the second connector, thereby causing the electrical connector assembly (in particular, the adaptor) to fail as a result of buckling and the like when the first and second connector are brought closer together.

The present invention, which was devised to eliminate the above-described issues, has the object of providing an electrical connector assembly capable of reliably restricting the tilting of an adaptor connected to a connector to a predetermined angle or less.

### Technical Solution

An electrical connector assembly according to one embodiment of the present invention is an electrical connector assembly comprising a connector and an adaptor inserted into the connector in the direction of mating and coupled to the connector, and is characterized in that the adaptor comprises a tubular portion extending in the axial direction from one end to the other end; the tubular portion has a generally cylindrically shaped supporting portion made of a rigid material, a plurality of resilient pieces that extend in a continuous manner in the axial direction from the supporting portion toward one end of the adaptor and that are separated by slits from each other in the circumferential direction and are capable of resilient deflection in the radial direction, and engagement portions in the distal end portions of the resilient pieces; the connector comprises a main body portion having an opening into which one end of the adaptor is inserted; the main body portion has a peripheral wall that forms a recess portion extending in the direction of mating from one end to the other end of the connector and having an opening at the other end; and, once the adaptor is tilted a predetermined angle from the direction of mating relative to the connector while the adaptor is engaged in a mated state, the supporting portion of the adaptor is configured to restrict further tilting of the adaptor by abutting the peripheral wall of the connector.

### Technical Effect

In accordance with the present invention, it is possible to provide an electrical connector assembly capable of reliably restricting the tilting of an adaptor connected to a connector to a predetermined angle or less.

### BRIEF DESCRIPTION OF DRAWINGS

FIG. 1 is an illustrative view of an electrical connector assembly according to an embodiment of the present invention.

FIG. 2 is a cross-sectional view of an electrical connector assembly according to an embodiment of the present invention.

FIG. 3 is an enlarged partial cross-sectional view of an electrical connector assembly according to an embodiment of the present invention.

FIG. 4 is a partial cross-sectional view illustrating a mated state in which an adaptor in an electrical connector assembly according to an embodiment of the present invention has not been tilted.

FIG. 5 is a partial cross-sectional view illustrating a mated state in which an adaptor in an electrical connector assembly according to an embodiment of the present invention has been tilted.

FIGS. 6 (A) to 6 (C) are views of the operation of mating of an electrical connector assembly according to an embodiment of the present invention.

FIGS. 7 (A) and 7 (B) are views of the operation of mating of an electrical connector assembly according to an embodiment of the present invention.

FIG. 8 is an illustrative view of an electrical connector assembly according to another embodiment of the present invention.

FIG. 9 is a partial cross-sectional view illustrating a mated state in which an adaptor in an electrical connector assembly according to another embodiment of the present invention has not been tilted.

FIG. 10 is a partial cross-sectional view illustrating a mated state in which an adaptor in an electrical connector assembly according to another embodiment of the present invention has been tilted.

### DETAILED DESCRIPTION

Some embodiments of the invention will be described below with reference to the drawings. It should be noted that, in principle, the same reference numerals have been assigned to the same parts in all drawings used to illustrate the embodiments, and any further descriptions thereof have been omitted. In addition, despite the fact that the embodiments are described independently, this does not preclude forming the electrical connector assembly as a combination of the respective components.

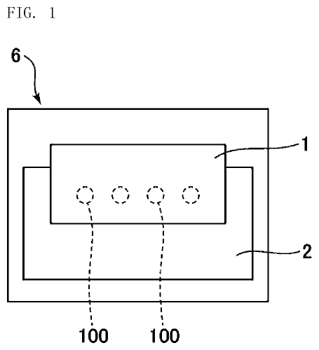

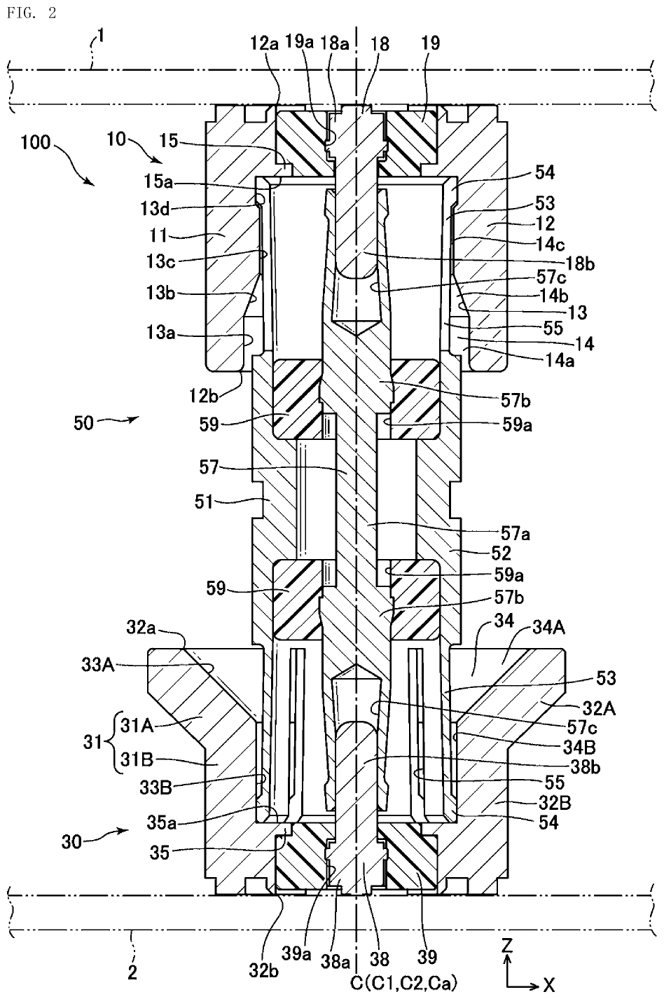

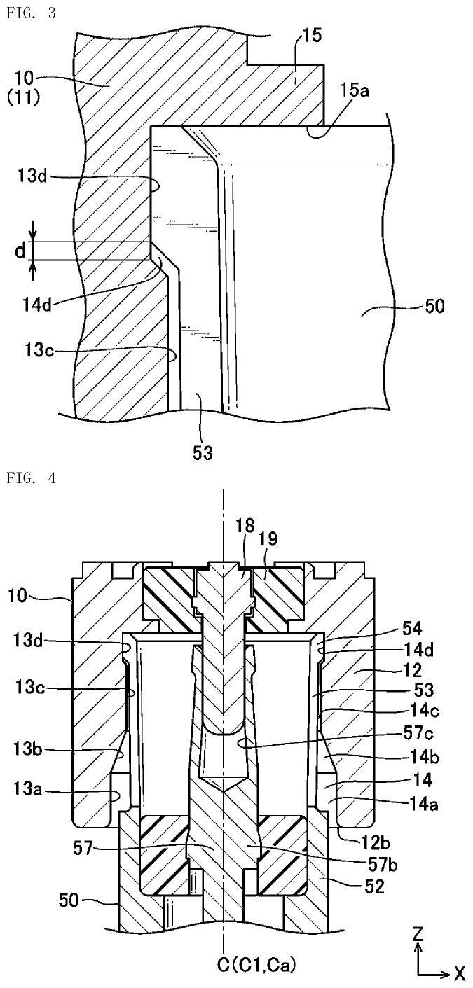

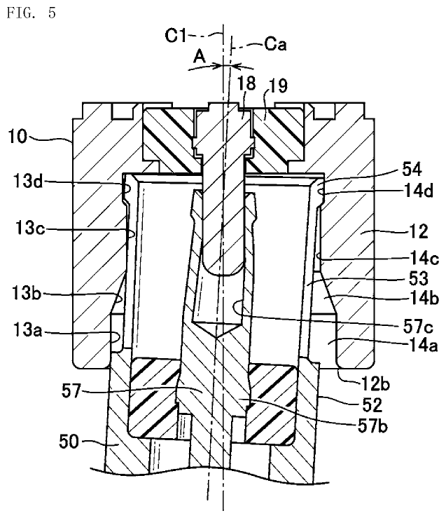

First, the construction of an electrical connector assembly according to an embodiment of the present invention will be described with reference to FIGS. 1-5. FIG. 1 is an illustrative view of the electrical connector assembly, FIG. 2 is a cross-sectional view of the electrical connector assembly, and FIG. 3 is an enlarged partial cross-sectional view of the electrical connector assembly. FIG. 4 is a partial cross-sectional view illustrating a mated state in which the adaptor in the electrical connector assembly has not been tilted, and FIG. 5 is a partial cross-sectional view illustrating a mated state in which the adaptor has been tilted.

As shown in FIG. 1, the electrical connector assembly 100 according to an embodiment of the present invention is used, for instance, in an antenna device 6 forming part of 5G base station equipment and the like, in order to directly connect a first board 1, which is an antenna board having a plurality of antenna elements disposed thereon, and a second board 2, which is an RF board, arranged in an opposed relationship. In the example of FIG. 1, the first board 1 and second board 2 are coupled by a plurality of (4 in FIG. 1) electrical connector assemblies 100.

As shown in FIG. 2, the electrical connector assembly 100 comprises a first connector 10, which is attached to the first board 1, a second connector 30, which is attached to the second board 2, and an adaptor 50 (also referred to as “interposer”), which connects these connectors. The first connector 10, second connector 30, and adaptor 50 have a coaxial construction comprising a central section and an external cylindrical section extending in the axial direction along the respective central axes C1, C2, and Ca. In FIG. 2, they are coupled to each other in the direction of mating Z (in FIG. 2, in the vertical direction) along a central axis C in an aligned state in which these central axes C1, C2, and Ca coincide. (When these central axes coincide, they are referred to as the “central axis C.”) In the coupled state, the electrical connector assembly 100 has a height of about 10-30 mm in the direction of mating Z.

The electrical connector assembly 100 has a center conductor section, which is connected to radio-frequency signal lines on the first board 1 and second board 2, and an external conductor section, which operates as an electromagnetic shield protecting against external noise. The outer conductor section is coupled to ground via the first board 1 and second board 2. It should be noted that the first connector 10 may be attached to the second board 2, and the second connector 30 may be attached to the first board 1. In the present embodiment, the adaptor 50 has a vertically symmetrical shape.

As shown in FIG. 2, the first connector 10 comprises a main body portion 11 serving as an outer conductor section, a center conductor 18 serving as a center conductor section, and a fixture portion 19 that secures the center conductor 18 to the main body portion 11. The main body portion 11 has a generally cylindrical shape and extends from one end to the other end (in FIG. 2, from top to bottom) along the axial direction. In FIG. 2, the axial direction is the direction in which the central axis C extends and coincides with the direction of mating Z. The center conductor 18 has a generally cylindrical shape and extends inside the main body portion 11 along the axial direction in coaxial alignment with the main body portion 11. The fixture portion 19 has a generally disk-like shape having an axial thickness and secures the center conductor 18 to the main body portion 11 in an electrically insulated state. The main body portion 11 and center conductor 18 are formed of an electrically conductive material (for example, metal), and the fixture portion 19 is formed of an electrically insulating material.

The center conductor 18 has a base portion 18a attached to a board, and a connection portion 18b coupled to the base portion 18a and connected via insertion to the adaptor 50, with the connection portion 18b being located within a recess portion 14, i.e., within the interior space of the main body portion 11, without protruding externally from the recess portion 14. The fixture portion 19 has an attachment opening 19a disposed axially therethrough for inserting the base portion 18a of the center conductor 18.

The main body portion 11 has a generally cylindrically shaped peripheral wall 12, and the generally cylindrically shaped recess portion 14 is formed by an inner peripheral surface 13 within the peripheral wall 12. The main body portion 11, which is made of a rigid material, is configured to prevent easy deflection. The recess portion 14 extends therethrough from a circular opening 12a at one end to a circular opening 12b at the other end. An annular flange portion 15, which extends protruding radially inwardly from the inner peripheral surface 13, is provided at one end of the recess portion 14. The fixture portion 19 is inserted into the recess portion 14 through the opening 12a at one end and reaches the flange portion 15. The flange portion 15 is a bottom portion. In other words, once the adaptor 50 is inserted into the recess portion 14 through the opening 12b at the other end, an annular surface 15a (in FIG. 2, the lower surface), which is located on the other side of the flange portion 15, serves as a bottom portion that abuts the distal end portion of the adaptor 50.

In the recess portion 14, within the space between the opening 12b at the other end and the flange portion 15, the inside diameter of the inner peripheral surface 13 is not constant and is formed so as to vary in the axial direction. In order to facilitate insertion of the adaptor 50, the opening 12b has larger inside diameter dimensions than the outside diameter of the adaptor 50 (tubular portion 51). Further, the opening-side inner peripheral surface 13a, which has generally the same inside diameter as the opening 12b, extends in a continuous manner from the opening 12b toward one end. An increased-diameter recess portion 14a is formed by the inner peripheral surface 13a.

In addition, a guiding inner peripheral surface 13b extends with its diameter gradually decreasing in a continuous manner from the opening-side inner peripheral surface 13a toward one end. A guiding recess portion 14b is formed by an inner peripheral surface 13b. Furthermore, a bottom-side supporting inner peripheral surface 13c, which has generally the same inside diameter dimensions, extends in a continuous manner from the guiding inner peripheral surface 13b toward one end. The supporting inner peripheral surface 13c has its inside diameter set the smallest within the inner peripheral surface 13 in a manner to be spaced apart from the adaptor 50 (resilient pieces 53) just by a predetermined radial dimension once the adaptor 50 is inserted into the recess portion 14. A supporting recess portion 14c of standard inside diameter dimensions is formed by the supporting inner peripheral surface 13c.

Furthermore, as shown in FIG. 3, a bottom inner peripheral surface 13d, i.e., the part of the inner peripheral surface 13 adjacent to the flange portion 15, is expanded radially outwardly of the supporting inner peripheral surface 13c for locking the adaptor 50. An expanded recess portion 14d is formed by the bottom inner peripheral surface 13d. In other words, within the recess portion 14, the supporting recess portion 14c is of standard inside diameter dimensions, and there are provided an increased-diameter recess portion 14a of an increased diameter for inserting the adaptor 50, a guiding recess portion 14b for guiding the adaptor 50 toward the central axis C, and an expanded recess portion 14d expanded radially outwardly for locking the adaptor 50.

Further, as shown in FIG. 2, the second connector 30 comprises a main body portion 31 serving as an outer conductor section, a center conductor 38 serving as a center conductor section, and a fixture portion 39 that secures the center conductor 38 to the main body portion 31. The main body portion 31 has a barrel portion 31B extending from the other end toward said one end (in FIG. 2, from bottom to top) along the axial direction, and an increased-diameter portion 31A increasing in diameter as one moves from the barrel portion 31B toward one end. The center conductor 38, which is identical to the center conductor 18, has a generally cylindrical shape and extends inside of the main body portion 31 along the axial direction in coaxial alignment with the main body portion 31. The fixture portion 39, which is identical to the fixture portion 19, has a generally disk-like shape having an axial thickness and secures the center conductor 38 to the main body portion 31 in an electrically insulated state. The main body portion 31 and the center conductor 38 are formed of an electrically conductive material (for example, metal) and the fixture portion 39 is formed of an electrically insulating material.

In the same manner as the center conductor 18, the center conductor 38 has a base portion 38a attached to a board, and a connection portion 38b coupled to the base portion 38a and connected via insertion to the adaptor 50, with the connection portion 38b being located within a recess portion 34, i.e., within the interior space of the main body portion 31, without protruding externally from the recess portion 34. The fixture portion 39 has an attachment opening 39a disposed axially therethrough for inserting the base portion 38a of the center conductor 38.

The barrel portion 31B of the main body portion 31 has a generally cylindrically shaped peripheral wall 32B, and a generally cylindrically shaped recess portion 34B is formed by an inner peripheral surface 33B within the peripheral wall 32B. In addition, the increased-diameter portion 31A has a peripheral wall 32A that is continuous with the barrel portion 31B and increases in diameter toward one end, and a generally frusto-conically shaped recess portion 34A is formed within the peripheral wall 32A by the inner peripheral surface 33A in continuity with the recess portion 34B. The recess portion 34, which comprises the recess portions 34A, 34B, extends from a circular opening 32a at one end to a circular opening 32b at the other end. An annular flange portion 35, which extends protruding radially inwardly from the inner peripheral surface 33B, is provided at the other end of the recess portion 34. The fixture portion 39 is inserted into the recess portion 34 through the opening 32b at the other end and reaches the flange portion 35. The flange portion 35 is a bottom portion. In other words, once the adaptor 50 is inserted into the recess portion 34 through the opening 32a at one end, an annular surface 35a (in FIG. 2, the upper surface), which is located on the one side of the flange portion 35, serves as a bottom portion that abuts the distal end portion of the adaptor 50.

The recess portion 34A decreases in diameter from the opening 32a at one end toward the other end, with the inner peripheral surface 33A serving as a guiding portion. In other words, when the adaptor 50 is inserted, the distal end portion of the adaptor 50 abuts the inner peripheral surface 33A, which is configured to guide the adaptor 50 toward the central axis C. On the other hand, the recess portion 34B has generally the same inside diameter dimensions from one end to the other end along the direction of mating Z. In addition, unlike the first connector 10, no expanded recess portion is provided in the vicinity of the bottom portion of the recess portion 34B. Therefore, once inserted into the recess portion 34B, the adaptor 50 is coupled to the second connector 30 by resiliently abutting the main body portion 31 under the action of a resilient force with which the distal end portion of the adaptor 50 tends to expand toward the inner peripheral surface 33B of the recess portion 34B. At such time, a gap of predetermined dimensions in the radial direction is formed between the adaptor 50 (resilient pieces 53) and the inner peripheral surface 33B of the recess portion 34B.

Further, as shown in FIG. 2, the adaptor 50 comprises a tubular portion 51 serving as an outer conductor section, a center conductive portion 57 serving as an inner conductor section, and support fixture portions 59 that secure the center conductive portion 57 to the tubular portion 51. The adaptor 50 has a shape that is symmetrical in the vertical direction of FIG. 2. The tubular portion 51 has a generally cylindrical shape and extends from one end to the other end along the axial direction (in FIG. 2, from top to bottom). The center conductive portion 57 has a generally cylindrical shape and extends inside the tubular portion 51 along the axial direction in coaxial alignment with the tubular portion 51. The support fixture portions 59, which are disposed in a spaced-apart relationship at 2 locations in the axial direction, have a generally disk-like shape having an axial thickness and secure the center conductive portion 57 to the tubular portion 51 in an electrically insulated state. The tubular portion 51 and center conductive portion 57 are formed of an electrically conductive material (for example, metal), and the support fixture portions 59 are formed of an electrically insulating material.

The center conductive portion 57 has a coupling portion 57a, which extends in the axial direction, and connection portions 57b, 57b, which extend axially toward one end and the other end from the opposite sides of the coupling portion 57a in the axial direction. The connection portions 57b have connecting recess portions 57c, which receive the connection portions 18b, 38b of the center conductors 18, 38 of the first connector 10 and second connector 30. When the connection portions 18b, 38b are inserted into the connecting recess portions 57c of the connection portions 57b, the connection portions 18b, 38b are placed in contact with, and electrically connected to, the connection portions 57b. The support fixture portions 59 have attachment openings 59a disposed therethrough in the axial direction for inserting the connection portions 57b of the center conductive portion 57.

The tubular portion 51 has a generally cylindrically shaped supporting portion 52, a plurality of resilient pieces 53 extending toward one end and the other end from the opposite sides of the supporting portion 52 in the axial direction, and engagement portions 54 protruding radially outwardly from the distal end portions of the resilient pieces 53. In the present embodiment, there are four slits 55 formed in the circumferential direction, with each of the slits extending in the axial direction, thereby forming four resilient pieces 53 and engagement portions 54. Adjacent resilient pieces 53 and engagement portions 54 are separated from each other in the circumferential direction by the slits 55. In the present embodiment, at one end and the other end of the adaptor 50, the slits 55 are formed at a pitch of 45° with respect to one another in the circumferential direction. In the thus-configured tubular portion 51, the resilient pieces 53 are capable of resilient deflection in the radial direction, but the supporting portion 52 is configured to prevent easy deflection owing to the generally cylindrically shaped construction made of a rigid material.

Upon insertion into the adaptor 50 from one end and the other end, the support fixture portions 59 are respectively secured to the opposite sides of the supporting portion 52 in the axial direction. The coupling portion 57a of the center conductive portion 57 is inserted and secured in the attachment openings 59a of the support fixture portions 59, which allows for the center conductive portion 57 and tubular portion 51 to be disposed coaxially in an electrically insulated state.

When they are not coupled to the first connector 10 and second connector 30, the resilient pieces 53 are slightly radially outwardly expanded toward the distal ends. When the adaptor 50 is inserted into the first connector 10 and second connector 30, as a result of abutting the respective inner peripheral surfaces directly or indirectly through the medium of the engagement portions 54, the resilient pieces 53 are resiliently radially inwardly compressed in a manner to extend along the axial direction.

Specifically, when the adaptor 50 is coupled to the second connector 30, a mated state is obtained by inserting the resilient pieces 53 of the adaptor 50 into the recess portion 34 of the second connector 30. In other words, since the engagement portions 54 abut the inner peripheral surface 33A of a gradually decreasing diameter and the inner peripheral surface 33B of a generally constant inside diameter when the resilient pieces 53 of the adaptor 50 are inserted into the recess portion 34 of the second connector 30, the resilient pieces 53 are caused to retreat radially inwardly to a position that is generally parallel to the axial direction, thereby allowing for the engagement portions 54 and inner peripheral surface 33B to be engaged under the action of a resilient force arising as a reaction to being caused to retreat.

On the other hand, when the adaptor 50 is coupled to the first connector 10, a mated state is obtained by inserting the resilient pieces 53 into the recess portion 14 of the first connector 10. In other words, since the engagement portions 54 abut the inner peripheral surface 13b of a gradually decreasing diameter and the inner peripheral surface 13c of a generally constant inside diameter when the resilient pieces 53 of the adaptor 50 are inserted into the recess portion 14 of the first connector 10, the resilient pieces 53 are caused to retreat radially inwardly to a position that is generally parallel to the axial direction. Upon further insertion, the engagement portions 54 are fitted into the expanded recess portion 14d and abut the bottom inner peripheral surface 13d. In this state, the resilient pieces 53 are maintained in a position that is generally parallel to the axial direction, which allows for the engagement portions 54 and the bottom inner peripheral surface 13d to be engaged under the action of a resilient force arising as a reaction to being caused to retreat in the radially inward direction.

Furthermore, at such time the engagement portions 54 are fitted into the expanded recess portion 14d, which causes the engagement portions 54 to be caught on the stepped portion between the bottom inner peripheral surface 13d and the guiding inner peripheral surface 13b, as a result of which the adaptor 50 is locked in a state that prevents decoupling. As long as the engagement portions 54 are caught on the stepped portion, a locked state is achieved even if the engagement portions 54 are not fully inserted into the expanded recess portion 14d. It should be noted that it is sufficient for at least a portion of the engagement portions 54 to be located within the expanded recess portion 14d in a mated or locked state. In other words, the engagement portions 54 do not have to be in direct contact with the inner peripheral surface 13d, in which case the resilient pieces 53 or the engagement portions 54 make contact with the inner peripheral surface 13c in the vicinity of the stepped portion.

In FIG. 4, the adaptor 50 is mated with the first connector 10 along the direction of mating Z such that the central axes C of the adaptor and first connector 10 coincide. The height of the peripheral wall 12 is set such that the resilient pieces 53 in their entirety and a portion of the supporting portion 52 are inserted into the recess portion 14 in such a mated state. In addition, the inside diameter of the recess portion 14 is set in a manner to provide a radial clearance between the adaptor 50 and the recess portion 14.

Furthermore, as shown in FIG. 3, the axial length of the expanded recess portion 14d of the first connector 10 is set in excess of the axial length of the engagement portions 54 of the adaptor 50 to allow for play d. For this reason, even in the mated state, in which the engagement portions 54 are fitted and locked into the expanded recess portion 14d, the adaptor 50 is movable or pivotable relative to the first connector 10 because of the play d and the deflection of the resilient pieces 53. In other words, the adaptor 50 is displaceable in a manner to tilt its central axis Ca with respect to the central axis C1 of the first connector 10.

FIG. 5 illustrates a state in which the adaptor 50 has been tilted to the maximum angle of tilt A relative to the first connector 10. In this example, the central axis Ca of the adaptor 50 has been tilted 3° relative to the central axis C1 of the first connector 10. In other words, the supporting portion 52, i.e., the rigid section of the adaptor 50, is configured to abut the peripheral wall 12, i.e. the rigid section of the first connector 10, once the adaptor 50 is tilted to the maximum angle of tilt A. At such time, the engagement portions 54 of the adaptor 50 remain locked within the expanded recess portion 14d of the first connector 10. In other words, if the supporting portion 52 did not abut the peripheral wall 12, the adaptor 50 could tilt or pivot further while remaining locked. However, in the present embodiment, the supporting portion 52 abuts the peripheral wall 12, thereby restricting the tilting of the adaptor 50 beyond the maximum angle of tilt A.

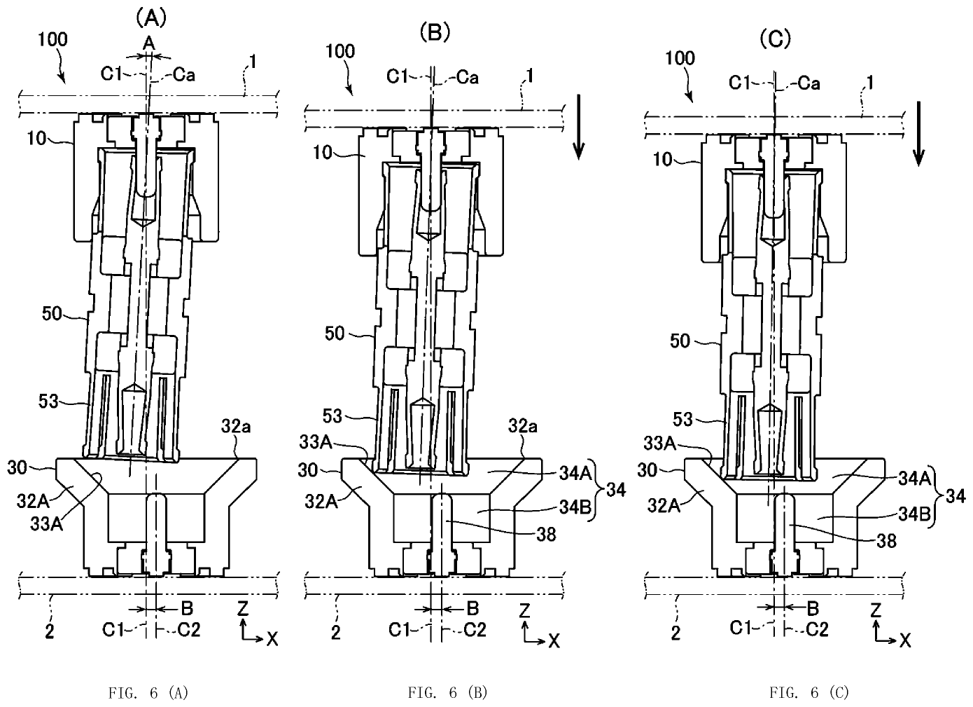

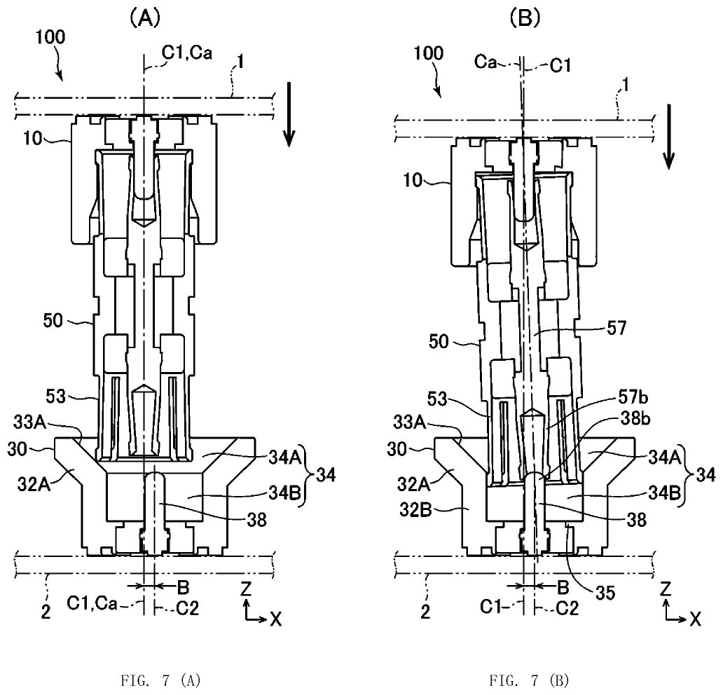

The operation of mating of the electrical connector assembly 100 will be described below with reference to FIGS. 6 and 7. FIGS. 6 and 7 are illustrative views of the operation of mating of the electrical connector assembly. First, in the same manner as in FIG. 5, a mated stated is obtained by inserting the adaptor 50 into the first connector 10. In FIG. 6 (A), the central axis Ca of the adaptor 50 has been tilted to the maximum angle of tilt A (3°) relative to the central axis C1 of the first connector 10. In this state, the positions of the central axis C1 of the first connector 10 and the central axis C2 of the second connector 30 are mutually aligned in parallel to the direction of mating Z.

It should be noted that if a plurality of corresponding first and second connectors are disposed respectively on the first board 1 and second board 2, it is impossible to bring the central axes C1, C2 of all the corresponding first and second connectors into alignment because of errors in the position of attachment of each connector to the boards. For this reason, in FIGS. 6 and 7, with the adaptor 50 tilted to the maximum angle of tilt A, the central axes C1, C2 are parallel to the direction of mating Z but offset by an allowable lateral distance B (for example, 0.4 mm) from each other in the lateral direction X normal to the direction of mating Z.

As the first connector 10 and second connector 30 are brought closer together in the direction of mating Z starting from the state depicted in FIG. 6 (A), the resilient pieces 53 at the other end of the adaptor 50 abut the umbrella-like inner peripheral surface 33A that serves as a guiding portion within the increased-diameter peripheral wall 32A of the second connector 30. In the present embodiment, the inside diameter of the opening 32a is set such that the resilient pieces 53 abut the inner peripheral surface 33A even with an offset by the allowable distance B.

In FIG. 6 (B), as a result of further approach, the other end of the adaptor 50 is guided by the inner peripheral surface 33A toward the center conductor 38 in the radial center of the second connector 30. Specifically, the central axis Ca of the adaptor 50 is caused to retreat to an angle (2°) smaller than the maximum angle of tilt relative to the central axis C1. In FIG. 6 (C), as a result of further approach, it is caused to retreat to an even smaller angle (1°).

Furthermore, in FIG. 7 (A), as a result of further approach, the central axis Ca is caused to retreat until it becomes parallel to the direction of mating Z and the central axis C1. In other words, the angle of tilt becomes 0°. Although in this state the central axis Ca of the adaptor 50 and the central axis C2 of the second connector 30 are parallel to each other, they are offset by an allowable distance B (0.4 mm) from each other in the X direction perpendicular to the direction of mating Z. Further approach at this point causes the resilient pieces 53 of the adaptor 50 to be guided by the inner peripheral surface 33A of the second connector 30 toward the entrance to the recess portion 34B within the generally cylindrically shaped peripheral wall 32B of the second connector 30. In addition, the connection portion 57b of the center conductive portion 57 of the adaptor 50 abuts the connection portion 38b of the center conductor 38 of the second connector 30. In this state, the central axis Ca of the adaptor 50 has an inverse angle of tilt (−2°) in the X direction.

When the first connector 10 and second connector 30 are brought even closer together starting from the state depicted in FIG. 7 (B), the resilient pieces 53, while being resiliently deflected, are inserted into the recess portion 34B of the second connector 30 and reach the flange portion 35, that is, the bottom portion of the recess portion 34B. This completes the coupling of the electrical connector assembly 100.

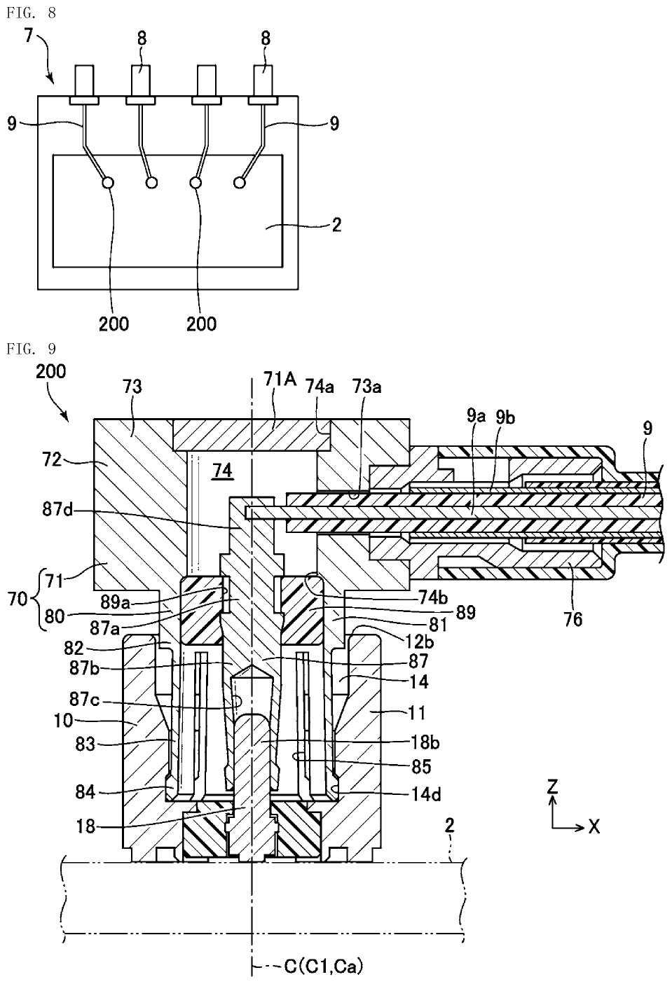

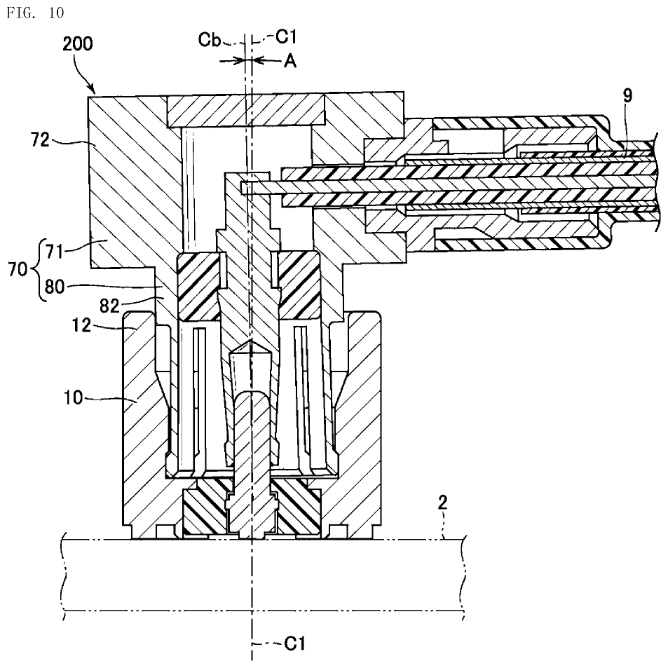

An electrical connector assembly 200 according to another embodiment of the present invention will be described below with reference to FIGS. 8-10. FIG. 8 is an illustrative view of the electrical connector assembly, FIG. 9 is a partial cross-sectional view illustrating a mated state in which the adaptor in the electrical connector assembly has not been tilted, and FIG. 10 is a partial cross-sectional view illustrating a mated state in which the adaptor has been tilted.

It should be noted that, for ease of understanding, elements of the electrical connector assembly 200 in common with the electrical connector assembly 100 are referred to by the same reference numerals and further descriptions thereof are omitted. As shown in FIG. 8, the electrical connector assembly 200 is used for connecting the proximal end portion of a coaxial cable 9, which has an antenna element 8 connected to the distal end portion thereof, and a second board 2, which is an RF board, directly to each other, for example, in an antenna device 7 forming part of 5G base station equipment, similar to the electrical connector assembly 100. In the example of FIG. 8, a plurality of coaxial cables 9 are coupled by electrical connector assemblies 200 to a second board 2.

As shown in FIG. 9, the electrical connector assembly 200 comprises a first connector 10 mounted on a second board 2, and a third connector 70 connected to a coaxial cable 9. The third connector 70 comprises a connector main body 71, and an adaptor 80 extending in the direction of mating Z from the connector main body 71. The third connector 70 is equivalent to a component obtained by forming the adaptor 50 and the second connector 30 described in the embodiment above integrally as a single piece, with the adaptor 80 having a similar construction to the adaptor 50.

The connector main body 71, which constitutes an outer conductor section, comprises a main body portion 72 of a generally disk-like outer shape, and a cylindrically shaped securing member 76 that is attached to the main body portion 72 in a manner to extend in the X direction. The securing member 76 is also referred to as a cord tube. A generally cylindrically shaped recess portion 74, which extends in the direction of mating Z, is formed within a peripheral wall 73 that constitutes the main body portion 72. The recess portion 74, which is open on the opposite sides in the mating direction Z, has its upper opening 74a, depicted in FIG. 9, closed by a cover 71A attached thereto, and has its lower opening 74b placed in communication with the adaptor 80. In addition, an attachment opening 73a disposed through the peripheral wall 73 in the X direction is provided in the lateral face of the peripheral wall 73.

The securing member 76, which is formed of an electrically conductive material, is plugged into and secured in the attachment opening 73a, as a result of which it is placed in electrical communication with the main body portion 72. The coaxial cable 9, which serves as a conductive line, comprises a center conductor 9a, an outer conductor 9b, an insulator that provides insulation between the center conductor 9a and the outer conductor 9b, and a sheath that covers the above. The securing member 76 supports the coaxial cable 9, which passes therethrough. The outer conductor 9b of the coaxial cable 9 is electrically connected to the securing member 76 using solder and the like. On the other hand, the center conductor 9a of the coaxial cable 9 extends through the attachment opening 73a and is electrically connected to the adaptor 80 using solder and the like within the recess portion 74.

The adaptor 80 comprises a tubular portion 81 serving as an outer conductor section, a center conductive portion 87 serving as an inner conductor section, and a support fixture portion 89 that secures the center conductive portion 87 to the tubular portion 81. The tubular portion 81 has a generally cylindrical shape and extends from one end to the other end (in FIG. 9, from bottom to top) along the axial direction. The center conductive portion 87 has a generally cylindrical shape and extends inside the tubular portion 81 along the axial direction in coaxial alignment with the tubular portion 81. The support fixture portion 89 has a generally disk-like shape having an axial thickness and secures the center conductive portion 87 to the tubular portion 81 in an electrically insulated state. The tubular portion 81 and center conductive portion 87 are formed of an electrically conductive material (for example, metal), and the support fixture portion 59 is formed of an electrically insulating material.

The center conductive portion 87 has a coupling portion 87a extending in the axial direction, and connection portions 87b, 87d extending axially toward one end and the other end from the opposite sides of the coupling portion 87a in the axial direction. The connection portion 87b has a connecting recess portion 87c that receives the connection portion 18b of the center conductors 18 of the first connector 10. When the connection portion 18b is inserted into the connecting recess portion 87c of the connection portion 87b, the connection portion 18b is placed in contact with, and electrically connected to, the connection portion 87b. On the other hand, the connection portion 87d is electrically connected to the center conductor 9a of the coaxial cable 9 using solder and the like within the recess portion 74. The support fixture portion 89 has an attachment opening 89a disposed therethrough in the axial direction for inserting the coupling portion 87a of the center conductive portion 87.

The tubular portion 81 has a generally cylindrically shaped supporting portion 82, a plurality of resilient pieces 83 extending axially from one end of the supporting portion 82 in the axial direction, and engagement portions 84 protruding radially outwardly from the distal end portions of the resilient pieces 83. In the present embodiment, four slits 85 are formed in the circumferential direction, with each of the slits extending in the axial direction, thereby forming four resilient pieces 83 and engagement portions 84. Adjacent resilient pieces 83 and engagement portions 84 are separated from each other in the circumferential direction by the slits 85. In the thus-configured tubular portion 81, the resilient pieces 83 are capable of resilient deflection in the radial direction, but the supporting portion 82 is configured to prevent easy deflection owing to having a generally cylindrically shaped construction made of a rigid material.

The support fixture portion 89 is inserted into the adaptor 80 from one end and is secured therein. The coupling portion 87a of the center conductive portion 87 is inserted and secured in the attachment opening 89a of the support fixture portion 89, thereby allowing for the center conductive portion 87 and the tubular portion 81 to be disposed coaxially in an electrically insulated state.

As described above, the adaptors 80 and 50 have similar constructions such that, in particular, the resilient pieces 83, engagement portions 84, and connection portion 87b are respectively of the same construction as the resilient pieces 53, engagement portions 54, and connection portions 57b, and have identical dimensions. Therefore, the adaptors 80 and 50 are coupled to the first connector 10 in a similar mated state.

In FIG. 9, the adaptor 80 is mated with the first connector 10 such that the central axis Cb of the adaptor 80 coincides with the central axis C1 of the first connector 10. In this state, the engagement portions 84 are locked in the expanded recess portion 14d. In addition, the resilient pieces 83 in their entirety and a portion of the supporting portion 82 are inserted into the recess portion 14. In addition, a radial clearance is formed between the adaptor 80 and the recess portion 14.

On the other hand, FIG. 10 illustrates a state in which the adaptor 80 has been tilted to the maximum angle of tilt A relative to the first connector 10. In this example, the central axis Cb of the adaptor 80 has been tilted 0.9° relative to the central axis C1 of the first connector 10. In other words, the supporting portion 82, i.e., the rigid section of the adaptor 80, is configured to abut the peripheral wall 12, i.e. the rigid section of the first connector 10, once the adaptor 80 is tilted to the maximum angle of tilt A. Therefore, in this embodiment, the outside diameter of the supporting portion 82 is set slightly in excess of the outside diameter of the supporting portion 52 of the embodiment above. At such time, a locked state is maintained. In other words, if the supporting portion 82 did not abut the peripheral wall 12, the adaptor 80 could tilt or pivot further while remaining locked. However, in the present embodiment, the supporting portion 82 abuts the peripheral wall 12, thereby restricting the tilting of the adaptor 80 beyond the maximum angle of tilt A.

The operation and effects of the above-described electrical connector assembly 100, 200 according to the present embodiments will be described below.

The electrical connector assembly 100, 200 according to the present embodiments comprises a first connector 10 and an adaptor 50, 80 inserted into the first connector 10 in the direction of mating Z and coupled to the first connector, and is configured such that the adaptor 50, 80 comprises a tubular portion 51, 81 extending in the axial direction from one end to the other end; the tubular portion 51, 81 has a generally cylindrically shaped supporting portion 52, 82 made of a rigid material, a plurality of resilient pieces 53, 83 that extend in a continuous manner in the axial direction from the supporting portion 52, 82 toward one end of the adaptor 50, 80 and that are separated by slits 55, 85 from each other in the circumferential direction and are capable of resilient deflection in the radial direction, and engagement portions 54, 84 in the distal end portions of the resilient pieces 53, 83; the first connector 10 comprises a main body portion 11 having an opening 12b into which one end of the adaptor 50, 80 is inserted; the main body portion 11 has a peripheral wall 12 that forms a recess portion 14 extending in the direction of mating Z from one end to the other end of the first connector 10 and having an opening 12b at the other end; and, once the adaptor 50, 80 is tilted a predetermined angle A from the direction of mating Z relative to the first connector 10 while the adaptor 50, 80 is engaged in a mated state, the supporting portion 52, 82 of the adaptor 50, 80 restricts further tilting of the adaptor 50, 80 by abutting the peripheral wall 12 of the first connector 10.

In accordance with the thus-configured present embodiments, once the adaptor 50, 80 is inserted into the first connector 10, a mated state is obtained, in which the resilient pieces 53, 83 are resiliently fitted into the recess portion 14. Although in this state the adaptor 50, 80 can be pivotally tilted with respect to the first connector 10, in the present embodiment, the supporting portion made of a rigid material 52, 82 and the peripheral wall 12 are configured to be brought into direct abutment once the adaptor 50, 80 is tilted a predetermined angle A. Consequently, due to the fact that the maximum angle of tilt A relative to the first connector 10 is reliably defined, the adaptor 50, 80 can reliably restrict the tilting of the adaptor 50, 80 to the maximum angle of tilt A or less even if an external force acts on the adaptor 50, 80 in the tilted state.

Further, in the electrical connector assembly 100, 200 according to the present embodiments, the main body portion 11 of the first connector 10 further comprises an annular expanded recess portion 14d that expands radially outwardly from the inner peripheral surface 13c of the peripheral wall 12 at one end of the recess portion 14, and the engagement portions 54, 84 of the adaptor 50, 80, which protrude radially outwardly from the distal end portions of the resilient pieces 53, 83, are resiliently mated with the expanded recess portion 14d of the first connector 10 in the mated state. In accordance with the thus-configured present embodiments, once the adaptor 50, 80 is inserted into the first connector 10, a mated state can be obtained, in which the engagement portions 54, 84 are resiliently fitted into the radially outer expanded recess portion 14d by the resilient pieces 53, 83, thereby locking the first connector 10 and the adaptor 50, 80 to each other.

In addition, in the electrical connector assembly 100, 200 according to the present embodiments, a clearance is formed between the resilient pieces 53, 83 of the adaptor 50, 80 and the peripheral wall 12 of the first connector 10 in the mated state at least when the adaptor 50, 80 is disposed along the direction of mating. In accordance with the thus-configured present embodiments, the adaptor 50, 80 can be tilted with respect to the first connector 10 in the mated state, which facilitates connection of the electrical connector assembly 100, 200 by allowing for dimensional errors during attachment.

In addition, in the electrical connector assembly 100, 200 according to the present embodiments, the recess portion 14 of the first connector 10 is formed such that in comparison with the inside diameter at one end, the inside diameter of the opening 12b at the other end is larger, and the radially outward surface of the supporting portion 52, 82 of the adaptor 50, 80 is located radially outwardly of the radially outward surface of the resilient pieces 53, 83. In accordance with the thus-configured present embodiments, in addition to facilitating insertion of the adaptor 50, 80 through the opening 12b of the first connector 10 into the recess portion 14, abutment of the supporting portion 52, 82 against the peripheral wall 12 is facilitated.

In addition, in the electrical connector assembly 100, 200 according to the present embodiments, the first connector 10 comprises a center conductor 18 extending from one end to the other end within the recess portion 14, and a fixture portion 19 made of an insulating material that secures the center conductor 18 to the main body portion 11. In accordance with the thus-configured present embodiments, it is possible to connect a coaxial line to the first connector 10, which is particularly advantageous for the transmission of radio-frequency signals.

In addition, in the electrical connector assembly 100, 200 according to the present embodiments, the adaptor 50, 80 comprises a center conductive portion 57, 87 extending from one end to the other end radially inwardly of the supporting portion 52, 82 and the plurality of resilient pieces 53, 83, and support fixture portions 59, 89 made of an insulating material that secure the center conductive portion 57, 87 to the supporting portion 52, 58. In accordance with the thus-configured present embodiments, it is possible to connect a coaxial line to the adaptor 50, 80, which is particularly advantageous for the transmission of radio-frequency signals.

In addition, the electrical connector assembly 100 according to a present embodiment further comprises a second connector 30 coupled to the other end of the adaptor 50. In accordance with the thus-configured present embodiment, when the first connector 10 and second connector 30 are coupled by the adaptor 50, the tilting of the adaptor 50 is restricted, thereby making it possible to prevent failure (buckling, etc.) of the adaptor 50 during connection.

In addition, in the electrical connector assembly 200 according to a present embodiment, the adaptor 80 is configured to have a conductive line (coaxial cable 9) connected at the other end. In accordance with the thus-configured present embodiment, a conductive line is connected to the adaptor 80, thereby making it possible to directly connect a conductive line to the first connector 10 while also making it possible to connect the adaptor 80 to the first connector 10 while restricting the tilting of the adaptor 80.

It should be noted that the individual embodiments of the present invention are not independent and can be appropriately implemented in combination with one another. In addition, the embodiments described above are illustrations used to explain the present invention, and the present invention is not limited to these embodiments. The present invention can be implemented in various forms without deviating from the essence thereof.

### INDUSTRIAL APPLICABILITY

The inventive electrical connector assembly can be employed for applications such as connecting coaxial cables and electronic boards used for the transmission of radio-frequency signals.

### DESCRIPTION OF THE REFERENCE NUMERALS

1 First board
2 Second board
6, 7 Antenna device
8 Antenna element
9 Coaxial cable
10 First connector
11 Main body portion
12 Peripheral wall
12a, 12b Opening
13, 13a, 13b, 13c, 13d Inner peripheral surface
14, 14a, 14b, 14c, 14d Recess portion
15 Flange portion
15a Annular surface
18 Center conductor
18a Base portion
18b Connection portion
19 Fixture portion
19a Attachment opening
30 Second connector
31 Main body portion
31A Increased-diameter portion
31B Barrel portion
32A, 32B Peripheral wall
32a, 32b Opening
33A, 33B Inner peripheral surface
34, 34A, 34B Recess portion
35 Flange portion
35a Annular surface
38 Center conductor
38a Base portion
38b Connection portion
39 Fixture portion
39a Attachment opening
50 Adaptor
51 Tubular portion
52 Supporting portion
53 Resilient piece
54 Engagement portion
55 Slit
57 Center conductive portion
57a Coupling portion
57b Connection portion
57c Connecting recess portion
59 Support fixture portion
59a Attachment opening
70 Third connector
71 Connector main body
71A Cover
72 Main body portion
73 Peripheral wall
73a Attachment opening
74 Recess portion
74a, 74b Opening
76 Securing member
80 Adaptor
81 Tubular portion
82 Supporting portion
83 Resilient piece
84 Engagement portion
85 Slit
87 Center conductive portion
87a Coupling portion
87b Connection portion
87c Connecting recess portion
87d Connection portion
89 Support fixture portion
89a Attachment opening
100, 200 Electrical connector assembly
C, C1, C2, Ca, Cb Central axis
X Lateral direction
Z Direction of mating
A Maximum angle of tilt

1. An electrical connector assembly comprising a connector and an adaptor inserted into the connector in the direction of mating and coupled to the connector, wherein:
the adaptor comprises a tubular portion extending in the axial direction from one end to the other end, the tubular portion having
a generally cylindrically shaped supporting portion made of a rigid material,
a plurality of resilient pieces that extend in a continuous manner from the supporting portion toward one end of the adaptor in the axial direction, and that are separated by slits from each other in the circumferential direction and are capable of resilient deflection in the radial direction, and
engagement portions in the distal end portions of the resilient pieces;
the connector comprises a main body portion having an opening into which one end of the adaptor is inserted, the main body portion having
a peripheral wall that forms a recess portion extending in the direction of mating from one end to the other end of the connector and having said opening at the other end; and
when the adaptor is tilted a predetermined angle from the direction of mating relative to the connector while the adaptor is engaged in a mated state, the supporting portion of the adaptor is configured to restrict further tilting of the adaptor by abutting the peripheral wall of the connector.

2. The electrical connector assembly according to claim 1, wherein the main body portion of the connector further comprises an annular expanded recess portion that expands radially outwardly from the inner peripheral surface of the peripheral wall at one end of the recess portion, and
the engagement portions of the adaptor protrude radially outwardly from the distal end portions of the resilient pieces, and resiliently mate with the expanded recess portion of the connector in the mated state.

3. The electrical connector assembly according to claim 1, wherein a clearance is formed between the resilient pieces of the adaptor and the peripheral wall of the connector in the mated state at least when the adaptor is disposed along the direction of mating.

4. The electrical connector assembly according to claim 1, wherein the recess portion of the connector is formed such that, in comparison with the inside diameter at one end, the inside diameter of the opening at the other end is larger, and
the radially outward surface of the supporting portion of the adaptor is located radially outwardly of the radially outward surface of the resilient pieces.

5. The electrical connector assembly according to claim 1, wherein the connector comprises a center conductor extending from one end to the other end within the recess portion, and a fixture portion made of an insulating material that secures the center conductor to the main body portion.

6. The electrical connector assembly according to claim 1, wherein the adaptor comprises a center conductive portion extending from one end to the other end radially inwardly of the supporting portion and the plurality of resilient pieces, and support fixture portions made of an insulating material that secure the center conductive portion to the supporting portion.

7. The electrical connector assembly according to claim 1, further comprising a second connector coupled to the other end of the adaptor.

8. The electrical connector assembly according to claim 1, wherein the adaptor is configured to have a conductive line connected at the other end.
